(19) United States
(12) Patent Application Publication
(10) Pub. No.: US 2004/0007229 A1
(43) Pub. Date: Jan. 15, 2004

(54) Collapsible reflector oven

(76) Inventor: Harley I. Sproul, Lincoln, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 10/191,623

(22) Filed: Jul. 10, 2002

(51) Int. Cl. A21B 1/00; A47J 37/00

(52) U.S. Cl. 126/274; 126/9 R; 126/25 R

(57) ABSTRACT

A collapsible reflector oven to be used for cooking in front of an open fire, such as a campfire, constructed of various panels having reflective inside surfaces and a food holder constructed of a non-reflecting, energy-absorbing material. The reflective surfaces of the panels direct heat energy from the fire into the food holder which absorbs the energy, becoming sufficiently hot to properly cook the food placed therein using the same recipes and cooking times as would be used in a conventional kitchen oven. The reflector oven may be collapsed for storage and unfolded for use.

### BACKGROUND OF THE INVENTION

1. Technical Field

The invention relates generally to reflector ovens used for cooking food in front of an open fire such as a campfire, and more particularly to an improved collapsible reflector oven designed to be light weight and easily portable and suitable to effectively cook food using the same recipes and cooking times as would be used in a conventional kitchen oven.

2. Description of Prior Art

Collapsible reflector ovens are well known in the industry. Several devices employing the basic concept of reflecting the heat energy of an open fire onto food in order to cook the food have been developed, with many of them having the added property of being collapsible for easy storage and portability. These devices are especially attractive to persons enjoying the outdoors where they will be away from conventional cooking means, such as campers, hunters, backpackers, and the like. Examples of collapsible reflector ovens are shown in U.S. Pat. Nos. 216,003 (Watson), 240,639 (Austin), 449,432 (Watson), 548,499 (Ashmore), 1,216,008 (Stonebridge), 2,520,030 (Cliff), 2,543,115 (Lindstaedt), 2,580,925 (Jarvis), 2,757,664 (McDowell), 2,921,577 (Smith), 3,026,866 (Lynch), and 5,983,887 (Bourgeois), the disclosure of each of which is incorporated herein by reference.

Previous reflector ovens have suffered from various problems, of which each of the successive inventions previously identified attempted to correct. However, the one problem that has never been adequately solved by the prior art is the actual cooking effectiveness of reflector ovens. The reflector ovens represented by the prior art fail to effectively cook food using the same recipes and cooking times as would be used in a conventional kitchen oven. This is largely due to the prior art reflector ovens failing to generate adequate heat and distributing the heat evenly to the food to be cooked. Many of the prior art reflector ovens were configured such that the rear of the ovens terminated in a vertex well behind the location of the food and distant from the energy source, causing much of the reflected energy from the fire to be lost in the rear of the oven. See, e.g., Watson, Austin, Watson, Stonebridge, Cliff, Lindstaedt, Jarvis, McDowell, and Smith. The invention disclosed herein reduces this inefficiency by the oven having a rear panel oriented vertically directly behind the food, thereby directing energy onto the food and the food holder. In addition, many of the prior art reflector ovens made use of shelves to hold the food, which shelves were made of the same reflecting material as the sides of the ovens. See, e.g., Stonebridge, Lindstaedt, McDowell, Smith, Lynch, and Bourgeois. These food-supporting shelves reflect energy away from the bottom of the food to be cooked, resulting in lower overall heating of the food and uneven cooking. Finally, none of the prior art reflector ovens teach the use of a container to hold the food which is constructed of a non-reflecting, energy-absorbing material. The disclosed invention makes use of a food holder constructed of a non-reflecting, energy-absorbing material, which minimizes the wasteful reflection of energy away from the food, and more importantly becomes very hot by absorbing the energy directed therein by the reflective surfaces of the oven. So constructed, the food holder may attain temperatures as much as three times hotter than the air temperature within the oven, achieving temperatures similar to those found in a conventional kitchen oven.

It is an object of this invention to provide a new and improved reflector oven which retains the ease of use and portability of the prior art but improves upon the quality of the cooking function such that the user may cook foods in front of an open fire using the same recipes and cooking times as would be used in a conventional kitchen oven.

### SUMMARY

In one aspect, the invention is directed to a collapsible reflector oven to be used for cooking in front of an open fire, such as a campfire. The oven comprises a top panel, a bottom panel, a rear panel, a left side panel, a right side panel, and a food holder, whereby the top, bottom, rear, left side, and right side panels are constructed of a metallic material in which at least the inside surface of each panel is reflective, and the food holder is constructed of a non-reflecting, energy-absorbing material. The reflective surfaces of the panels direct heat energy from the fire into the food holder which absorbs the energy, becoming sufficiently hot to cook the food placed therein. The invention permits use of the same recipes and cooking times as would be used in a conventional kitchen oven.

This aspect may include one or more of the following features: the top and bottom panels are generally rectangular in shape, wider than deep, and of substantially identical dimensions; the rear panel is generally rectangular in shape, substantially the same width as the top and bottom panels but of lesser height; and the left and right side panels are generally trapezoidal in shape, with the front edges of greater height than the rear edges, and of substantially identical dimensions. The five panels are connected to each other along adjacent edges by hinge means, permitting the oven to be folded and unfolded, and the top panel is detachably attached to the two side panels by connection means. The food holder is comprised of a removable container created of a non-reflecting, energy-absorbing material, and two brackets attached to the inner surfaces of the two side panels which support the container in a generally horizontal orientation. The oven may include a handle attached to the top panel for moving the oven while it is in use, for example to regulate the cooking temperature, and may include a support foot attached to the bottom panel to hold the oven in a generally upright position while it is in use.

Other features and advantages of the invention are described below.

### DESCRIPTION OF DRAWINGS

FIG. 1 is a perspective front view of the reflector oven in the fully opened position, showing the interior of the oven and the food holder.

FIG. 2 is an exploded view of the hinge means connecting two panels.

FIG. 3 is a left side perspective view of the reflector oven, showing the handle and support foot and the reflector oven's orientation to a fire.

FIG. 4 is a perspective view of the reflector oven in a partially collapsed position.

### DESCRIPTION OF THE INVENTION

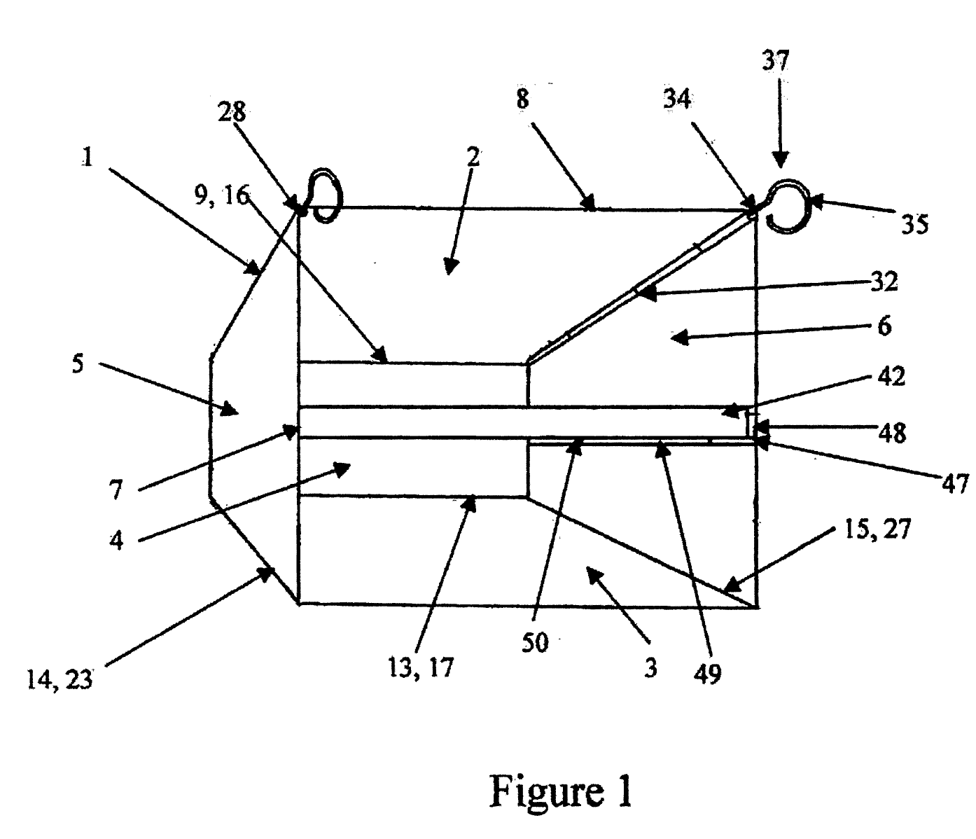

FIG. 1 shows a perspective front view of one embodiment of a reflector oven 1 as it is intended to be used in the fully opened position. The basic components of the reflector oven 1 include a top panel 2, a bottom panel 3, a rear panel 4, a left side panel 5, a right side panel 6, and a food holder 7. The panels are held together by a first connection means 28, a second connection means 29, and hinge means 30. The panels 2,3,4,5,6 constituting the reflector oven 1 are constructed of a metallic material in which at least the inside surface of each panel is reflective of the heat energy generated by an open fire 57. In one embodiment the panels are made of tinned sheet steel. The food holder 7 must include a container 42 constructed of a non-reflecting, energy-absorbing material. In one embodiment the container is a pan 43 made of blackened steel. The reflector oven 1 is used by placing the food 58 to be cooked in the container 42, placing the container 42 into the reflector oven 1, and placing the reflector oven 1 with its open front oriented towards an open fire 57, such as a camp fire. The heat energy of the open fire 57 is reflected by the panels 2,3,4,5,6 of the reflector oven 1 and directed towards the food 58 and the container 42. The container 42 absorbs the energy from the fire 57 and becomes much hotter than the air temperature within the reflector oven 1, thereby efficiently cooking the food 58 placed therein. The temperature of the reflector oven 1 is regulated by moving it closer or further from the fire 57. The food cooking properties of the reflector oven 1 are enhanced over the prior art by the use of the non-reflecting, energy-absorbing food holder 7, which allows for quicker, more even cooking of the food 58, thus permitting the use of recipes and cooking times devised for food preparation using conventional kitchen ovens.

The shapes of the panels 2,3,4,5,6 enhance the food cooking properties of the reflector oven 1. The top 2, rear 4, and bottom 3 panels are generally rectangular in shape, with a greater width side to side than depth front to back. This permits the reflector oven 1 to present a wider profile to the fire 57, allowing more of the energy of the fire 57 to be directed into the food holder 7. The left side panel 5 and right side panel 6 are generally trapezoidal in shape, with their rear edges 21,25 shorter then their front edges 20,24 and their top and bottom edges 23,23,26,27 substantially equal in length. The top panel 2 and bottom panel 3 are substantially of the same dimensions, and the left side panel 5 and the right side panel 6 are substantially of the same dimensions, thereby creating a generally symmetrical space within the reflector oven 1 above and below the food holder 7 to enhance the even heating and cooking of the food 58. The rear panel 4 presents a flat surface generally perpendicular to the food holder 7, allowing energy from the fire 57 to be better directed into the food holder 7 and not lost in the rear of the reflector oven 1. In one embodiment the top panel 2 is oriented at an angle approximately thirty degrees above the horizontal ascending from the back of the reflector oven 1 to the front, and the bottom panel 3 is oriented at an angle approximately thirty degrees below the horizontal descending from the back of the reflector oven 1 to the front. Other embodiments may orient the top panel 2 and bottom panel 3 at angles slightly greater or lesser than thirty degrees without compromising the effectiveness of the reflector oven 1.

The reflector oven 1 is constructed with most of its component parts permanently connected to each other to facilitate ease of set up and collapse. The five panels 2,3,4,5,6 are permanently connected to each other along common edges by hinge means 30, and the left side panel 5 is detachably attached to the top panel 2 by a first connection means 28 and the right side panel 6 is detachably attached to the top panel 2 by a second connection means 29. The five panels 2,3,4,5,6 so connected and attached form a five sided reflector oven 1. The specific connections points are as follows: the top panel 2 is connected to the rear panel 4 by a hinge means 30 connecting the rear edge 9 of the top panel 2 to the top edge 16 of the rear panel 4; the rear panel 4 is connected to the bottom panel 3 by a hinge means 30 connecting the bottom edge 17 of the rear panel 4 to the rear edge 13 of the bottom panel 3; the left side panel 5 is connected to the bottom panel 3 by a hinge means 30 connecting the bottom edge 23 of left side panel 5 to the left edge 14 of bottom panel 3; and the right side panel 6 is connected to the bottom panel 3 by a hinge means 30 connecting the bottom edge 27 of right side panel 6 to the right edge 15 of bottom panel 3. With the five panels 2,3,4,5,6 so connected by hinge means 30, they may be positioned to lie flat in an upside down “T” shape, with the top panel 2, rear panel 4, and bottom panel 3 forming one axis of the “T” and the left side panel 5, the bottom panel 3, and the right side panel 6 forming the other axis of the “T”.

The reflector oven 1 is readied for use by unfolding the five panels 2,3,4,5,6 into the flat “T” position described above. The left side panel 5 and the right side panel 6 are then positioned generally perpendicular to the bottom panel 3, the rear panel 4 is positioned such that the left edge 18 of the rear panel 4 is adjacent to the rear edge 21 of the left side panel 5 and the right edge 19 of the rear panel 4 is adjacent to the rear edge 25 of the right side panel 6. Finally, the top panel 2 is positioned such that the left edge 10 of the top panel 2 is adjacent to the top edge 22 of the left side panel 5 allowing the top panel 2 to be attached to the left side panel 5 by the first connection means 28, and the right edge 11 of the top panel 2 is adjacent to the top edge 26 of the right side panel 6 allowing the top panel 2 to be attached to the right side panel 6 by the second connection means 29. Once the outer structure of the reflector oven 1 is assembled, the container 42 is placed into the reflector oven 1.

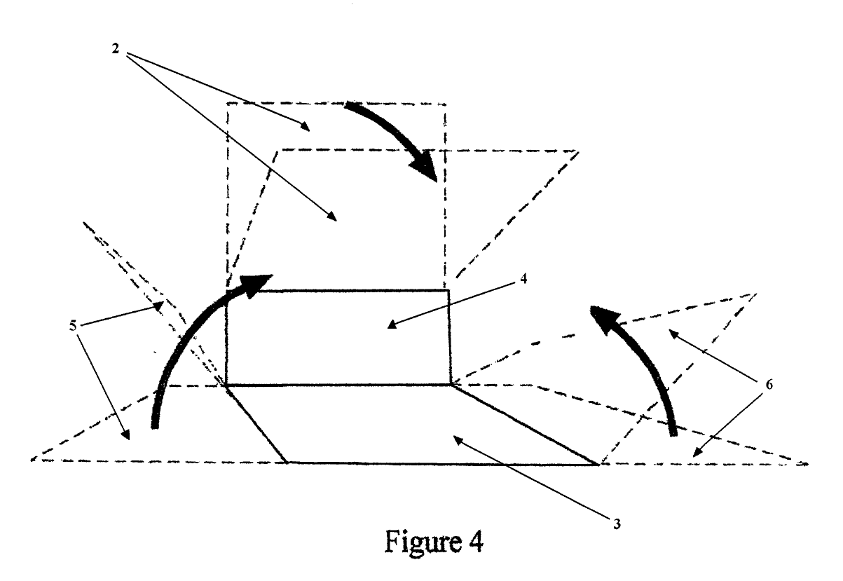

The reflector oven 1 is readied for storage by first removing the container 42 from the reflector oven 1, detaching the first connection means 28 and the second connection means 29, unfolding the five panels 2,3,4,5,6 into the flat “T” position described above, and then folding the left side panel 5 and the right side panel 6 onto the bottom panel 3 and folding the top panel 2 onto both the rear panel 4 and the bottom panel 3. FIG. 4 shows the reflector oven 1 partially collapsed and indicated how the panels 2,3,4,5,6 are to be folded. As so folded, the reflector oven 1 may be placed into a bag for storage 59, along with the container 42 and the removable components (if any) of the first and second connection means 28,29.

In one embodiment, the first connection means is formed into the left edge 10 of the top panel 2 and the top edge 22 of the left side panel 5. One or more flanges 31 extend from the left edge 10 of the top panel 2 and are curved back towards the left edge 10 of the top panel 2, forming a like number of cylindrical sleeves 32. Similarly, one or more flanges 31 extend from the top edge 22 of the left side panel 5 and are curved back towards the top edge 22 of the left side panel 5, forming a like number of cylindrical sleeves 32. Each cylindrical sleeve 32 is open at either end and has a uniform inside diameter. The internal axis of each cylindrical sleeve 32 is substantially aligned along the edge of the panel on which it is situated. The cylindrical sleeves 32 are situated along the left edge 10 of the top panel 2 and along the top edge 22 of the left side panel 5 in an alternating manner such that when the left edge 10 of the top panel 2 is positioned adjacent to and aligned with the top edge 22 of the left side panel 5, the individual cylindrical sleeves 32 align with each other end to end forming a continuous cylindrical aperture. A first connection pin 33 is then inserted into the cylindrical sleeves 32, thereby retaining the top panel 2 firmly in connection with the left side panel 5. The first connection pin 33 has a generally straight shaft 34 and has a shaped end 35. The length of the shaft 34 is just slightly longer than the length of the left edge 10 of the top panel 2 and the diameter of the shaft 34 is just slightly less than the inside diameter of the cylindrical sleeves 32. The shaped end 35 of the first connection pin 33 may be of any suitable shape, such that it stops the shaped end 35 of the first connection pin 33 from completely passing through the cylindrical sleeves 32. In one embodiment, the first connection pin 33 has a shaped end 35 in the shape of an eye-hook, facilitating easy grasping, and its opposite end is tapered 36, facilitating insertion of the first connection pin 33 into the cylindrical sleeves 32. The second connection means 29 is substantially identical to the first connection means 28, except that it is formed into the right edge 11 of the top panel 2 and the top edge 26 of the right side panel 6. Other embodiments of the first and second connection means 28,29 may be used without departing from the subject or spirit of the invention.

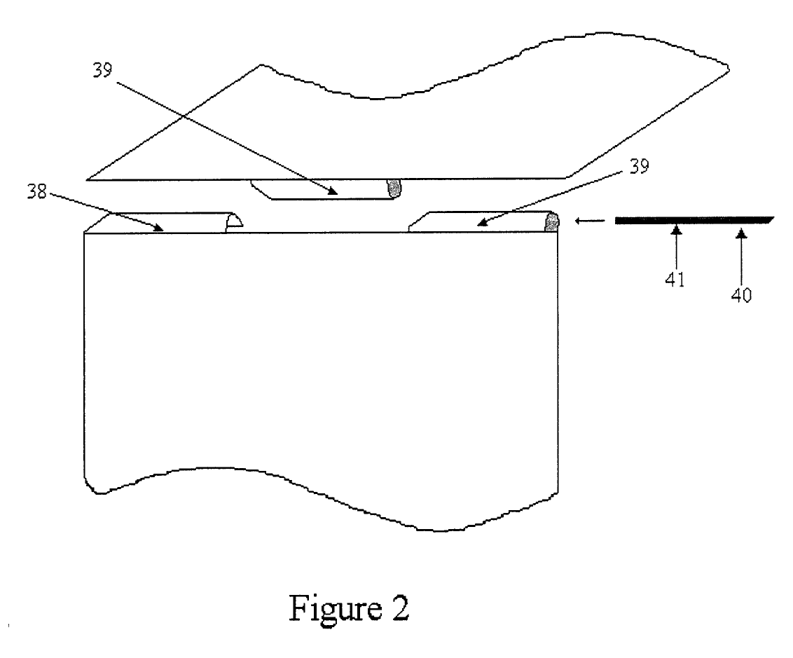

FIG. 2 shows one embodiment of the hinge means 30. In this embodiment, each hinge means 30 is formed into the adjacent edges of each pair of panels. One or more flanges 38 extend from the adjacent edge of the first panel in the pair and are curved back towards that edge, forming a like number of cylindrical hinge sleeves 39. Similarly, one or more flanges 38 extend from the adjacent edge of the second panel in the pair and are curved back towards that edge, forming a like number of cylindrical hinge sleeves 39. Each cylindrical hinge sleeve 39 is open at either end and has a uniform inside diameter. The internal axis of each cylindrical hinge sleeve 39 is substantially aligned along the edge of the panel on which it is situated. The cylindrical hinge sleeves 39 are situated along the adjacent edge of the first panel in the pair and along the adjacent edge of the second panel in the pair in an alternating manner such that when the adjacent edge of the first panel in the pair is positioned adjacent to and aligned with the adjacent edge of the second panel of the pair, the individual cylindrical hinge sleeves 39 align with each other end to end forming a continuous cylindrical aperture. A hinge pin 40 is then inserted into the cylindrical hinge sleeves 39, thereby retaining the pair of panels hingedly in connection with each other. The hinge pin 40 has a generally straight shaft 41 and is just slightly shorter than the length of the edge of the panels on which the cylindrical hinge sleeves 39 are situated. The diameter of the shaft 41 is just slightly less than the inside diameter of the cylindrical hinge sleeves 39. The open ends of the two cylindrical hinge sleeves 39 forming the ends of the continuous cylindrical aperture are crimped to retain the hinge pin 40 within the continuous cylindrical aperture. Other embodiments of the hinge means 30 may be used without departing from the subject or spirit of the invention.

FIG. 1 shows one embodiment of the food holder 7. In this embodiment, the food holder 7 is comprised of a removable container 42 and two brackets 44,47 attached to the inside surfaces of the left and right side panels 5,6. The left bracket 44 is angled approximately ninety degrees, thereby having a first plane 45 and a second plane 46 oriented approximately ninety degrees to each other. The first plane 45 of the left bracket 44 is attached to and flush with the inside surface of the left side panel 5 and situated slightly below a point midway between the top and bottom edges 22,23 of the left side panel 5. The left bracket 44 is oriented such that the second plane 46 of the left bracket 44 forms a generally horizontal shelf extending into the interior of the reflector oven 1. The width of the left bracket 44 is less than the width of the left side panel 5. The right bracket 47 is generally of the same shape and dimension as the left bracket 44, and is situated at point on the inside surface of the right side panel 6 corresponding to the location of the left bracket 44 on the left side panel 5. In one embodiment the brackets 44,47 are attached to the left and right side panels 5,6 by pop rivets 50. The food holder 7 is readied for use by placing the container 42 upon the second plane 46 of the left bracket 44 and the second plane 49 of the right bracket 47. In one embodiment the container 42 is a generally rectangular pan 43 with a substantially flat bottom, vertical sides, and open at the top, having a length slightly less than the width of the top panel 2 and a width slightly less than the width of the left side panel 5. Other embodiments of the food holder 7 may be used without departing from the subject or spirit of the invention, except that the container 42 must be constructed of a non-reflecting, energy-absorbing material.

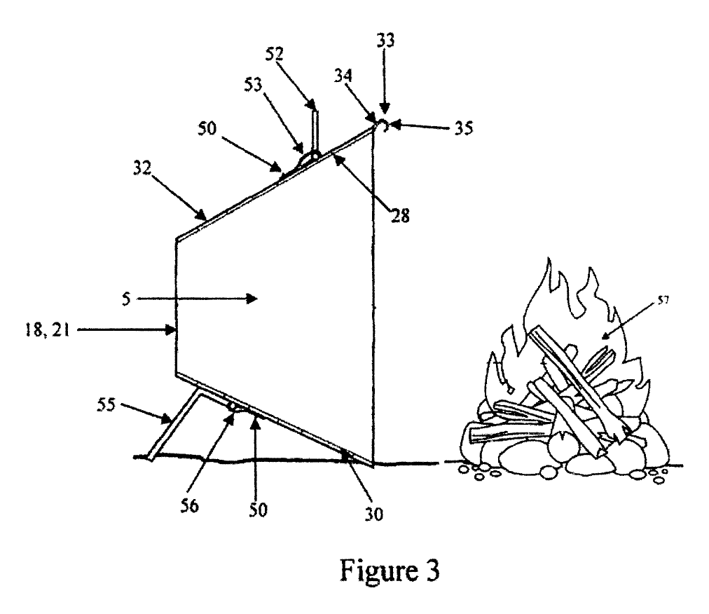

FIG. 3 shows a left side perspective view of the reflector oven 1 and an embodiment of the invention using a handle 51. The handle 51 is used to position the reflector oven i with respect to the fire 57, thereby regulating the cooking temperature. In this embodiment, the handle 51 is attached to the top panel 2. The handle 51 may also be foldable, so that it lies flat against the top panel 2 when not in use for easier storage. In the embodiment shown, the handle 51 is comprised of a rectangular grip 52 composed of a heavy gauge metal wire and an attachment plate 53. The attachment plate 53 has a generally rectangular shape and is folded against itself, with the fold having a generally cylindrical shape in which to contain one side of the rectangular grip 52. The fold of the attachment plate 53 accommodates the rectangular grip 52 snugly, such that the rectangular grip 52 may be pivoted by an application of minimal force but will not flop about on its own. In one embodiment the attachment plate 53 is attached to the top panel 2 by pop rivets 50. Other embodiments of the handle 51 may be used without departing from the subject or spirit of the invention.

FIG. 3 also shows an embodiment of the invention using a support foot 54. The support foot 54 is used to support the rear of the reflector oven 1 off the ground such that the reflector oven 1 will have a generally upright orientation and the container 42 will have a generally horizontal orientation. In this embodiment, the support foot 54 is attached to the bottom panel 3. The support foot 54 may also be foldable, so that it lies against the bottom panel 3 when not in use for easier storage. In the embodiment shown, the support foot 54 is comprised of a rectangular foot 55 composed of a heavy gauge metal wire and an attachment plate 56. The rectangular foot 55 has a first long side 55A and a second long side 55B opposite the first long side 55A and of substantially identical length to the first long side 55A and a first short side 55C and a second short side 55D opposite the first short side 55C and of substantially identical length to the first short side 55C. The attachment plate 56 has a generally rectangular shape and is folded against itself, with the fold having a generally cylindrical shape in which to contain the first long side 55A of the rectangular foot 55. The fold of the attachment plate 56 accommodates the rectangular foot 55 snugly, such that the rectangular foot 55 may be pivoted by an application of minimal force but will not flop about on its own. In this embodiment the rectangular foot 55 is angled substantially ninety degrees along its first short side 55C and its second short side 55D, with the angle being situated along the first and second short sides 55C,55D at substantially the same distance from the first long side 55A and closer to the first long side 55A than to the second long side 55B. The angled first and second short sides 55C,55D are oriented in the same direction, towards the front of the reflector oven 1. When the rectangular foot 55 is pivoted upward and forward, the second long side 55B comes in contact with the bottom panel 3, causing the support foot 54 to be relatively flat against the bottom of the reflector oven 1. When the rectangular foot 55 is pivoted downward and rearward, the angle of the rectangular foot 55 comes in contact with the bottom panel 3, resulting in the portion of the rectangular foot 55 located along the first and second short sides 55C,55D between the angle and the second long side 55B to be oriented in a generally downward position. The attachment plate 56 may be attached to the bottom panel 3 by pop rivets 50. Other embodiments of the support foot 54 may be used without departing from the subject or spirit of the invention.

In one embodiment, the front edge 8 of the top panel 2, the front edge 12 of the bottom panel 3, the front edge 20 of the left side panel 5, and the front edge 24 of the right side panel 6 are rolled back onto themselves forming rounded edges. These rounded edges prevent users of the reflector oven 1 from cutting themselves along the sharp exposed edges and also provide rigidity to the reflector oven 1. Similarly, the left edge 18 of the rear panel 4, the right edge 19 of the rear panel 4, the rear edge 21 of the left side panel 5, and rear edge 25 of the right side panel 6 are folded onto themselves forming hemmed edges. These hemmed edges prevent users of the reflector oven 1 from cutting themselves along the sharp exposed edges.

Modifications and variations can be made to the disclosed embodiments of the invention without departing from the subject or spirit of the invention as defined in the following claims.

What I claim:

1. A collapsible reflector oven comprising
a top panel;
a bottom panel;
a rear panel;
a left side panel;
a right side panel; and
a food holder,
wherein the top, bottom, rear, left side, and right side panels are constructed of a metallic material in which at least the inside surface of each panel is reflective, and the food holder is constructed of a non-reflecting, energy-absorbing material.

2. The device of claim 1 wherein
the top panel is generally rectangular in shape, with a front edge, a rear edge, a left edge, and a right edge, with the width of the top panel along the front edge substantially the same as the width of the top panel along the rear edge, and the height of the top panel along the left edge substantially the same as the height of the top panel along the right edge, and with the height of the top panel less than the width of the top panel,
the bottom panel is generally rectangular in shape, with a front edge, a rear edge, a left edge, and a right edge, and of substantially the same shape and size as the top panel,
the rear panel is generally rectangular in shape, with a top edge, a bottom edge, a left edge, and a right edge, with the width of the rear panel along the top edge substantially the same as the width of the rear panel along the bottom edge, and the height of the rear panel along the left edge substantially the same as the height of the rear panel along the right edge, and with the width of the rear panel substantially the same as the width of the top and bottom panels, and with the height of the rear panel less than the width of the rear panel,
the left side panel is generally trapezoidal in shape, with a top edge, a bottom edge, a front edge, and a rear edge, with the length of the top and bottom edges substantially the same, and with the height of the rear edge substantially the same as the height of the rear panel, and with the height of the front edge greater than the height of the rear edge, and
the right side panel is generally trapezoidal in shape, with a top edge, a bottom edge, a front edge, and a rear edge, and of substantially the same shape and size as the left side panel.

3. The device of claim 2, further comprising
a first connection means,
a second connection means, and
a hinge means,
whereby the first connection means detachably attaches the left edge of the top panel to the top edge of the left side panel,
the second connection means detachably attaches the right edge of the top panel to the top edge of the right side panel,
the rear edge of the top panel is connected by the hinge means to the top edge of the rear panel,
the bottom edge of the rear panel is connected by the hinge means to the rear edge of the bottom panel,
the bottom edge of the left side panel is connected by the hinge means to the left edge of the bottom panel, and
the bottom edge of the right side panel is connected by the hinge means to the right edge of the bottom panel.

4. The device of claim 3 wherein
the first connection means comprises
one or more flanges extending from the left edge of the top panel and curved back towards the left edge of the top panel forming a like number of cylindrical sleeves, each cylindrical sleeve open at both ends with a uniform inside diameter and with an internal axis substantially aligned with the left edge of the top panel,
one or more flanges extending from the top edge of the left side panel and curved back towards the top edge of the left side panel forming a like number of cylindrical sleeves, each cylindrical sleeve open at both ends with a uniform inside diameter substantially the same as the inside diameter of the cylindrical sleeves of the left edge of the top panel and with an internal axis substantially aligned with the top edge of the left side panel, and
a first connection pin consisting of a generally straight shaft and one shaped end, with the length of the shaft just slightly longer than the height of the left edge of the top panel and the diameter of the shaft just slightly less than the inside diameter of a cylindrical sleeve of the left edge of the top panel, and with the shaped end being of a suitable shape so as to prevent the shaped end from passing through a cylindrical sleeve of the left edge of the top panel,
whereby the cylindrical sleeves are situated along the left edge of the top panel and along the top edge of the left side panel in an alternating manner such that when the left edge of the top panel is positioned adjacent to and aligned with the top edge of the left side panel the individual cylindrical sleeves align with each other end to end forming a continuous cylindrical aperture into which the first connection pin may be inserted to retain the top panel firmly in connection with the left side panel, and
the second connection means comprises
one or more flanges extending from the right edge of the top panel and curved back towards the right edge of the top panel forming a like number of cylindrical sleeves, each cylindrical sleeve open at both ends with a uniform inside diameter and with an internal axis substantially aligned with the right edge of the top panel,
one or more flanges extending from the top edge of the right side panel and curved back towards the top edge of the right side panel forming a like number of cylindrical sleeves, each cylindrical sleeve open at both ends with a uniform inside diameter substantially the same as the inside diameter of the cylindrical sleeves of the right edge of the top panel and with an internal axis substantially aligned with the top edge of the right side panel, and
a second connection pin consisting of a generally straight shaft and one shaped end, with the length of the shaft just slightly longer than the height of the right edge of the top panel and the diameter of the shaft just slightly less than the inside diameter of a cylindrical sleeve of the right edge of the top panel, and with the shaped end being of a suitable shape so as to prevent the shaped end from passing through a cylindrical sleeve of the right edge of the top panel,
whereby the cylindrical sleeves are situated along the right edge of the top panel and along the top edge of the right side panel in an alternating manner such that when the right edge of the top panel is positioned adjacent to and aligned with the top edge of the right side panel the individual cylindrical sleeves align with each other end to end forming a continuous cylindrical aperture into which the second connection pin may be inserted to retain the top panel firmly in connection with the right side panel.

5. The device of claim 4 wherein
the shaped end of the first connection pin is in the shape of an eye-hook and the opposite end is tapered, and
the shaped end of the second connection pin is in the shape of an eye-hook and the opposite end is tapered.

6. The device of claim 3 wherein the hinge means connecting each pair of panels comprises
one or more flanges extending from each adjacent edge of the panels and curved back towards the edge of that panel forming a like number of cylindrical hinge sleeves, each cylindrical hinge sleeve open at both ends with a uniform inside diameter and with an internal axis substantially aligned with the edge of that panel, and
a hinge pin consisting of a generally straight shaft, with the length of the shaft just slightly shorter than the length of the adjacent edges of the panels and the diameter of the shaft just slightly less than the inside diameter of a cylindrical hinge sleeve,
whereby the cylindrical hinge sleeves are situated along the adjacent edges of the panels in an alternating manner such that when the panels are positioned adjacent to and aligned with each other the individual cylindrical hinge sleeves align with each other end to end forming a continuous cylindrical aperture into which the hinge pin is inserted, creating a fulcrum about which the panels may pivot, and with the open ends of the two cylindrical hinge sleeves forming the ends of the continuous cylindrical aperture crimped to retain the hinge pin within the continuous cylindrical aperture.

7. The device of claim 3 whereby the food holder comprises
a container,
a left bracket having a first plane and a second plane oriented approximately ninety degrees to each other, and having a width less than the width of the left side panel, whereby the first plane of the left bracket is attached to and flush with the inside surface of the left side panel and the second plane of the left bracket extends into the interior of the oven, with the left bracket situated slightly below a point midway between the top and bottom edges of the left side panel and oriented such that the second plane of the left bracket forms a generally horizontal shelf, and
a right bracket having a first plane and a second plane oriented approximately ninety degrees to each other, and having a width less than the width of the right side panel, whereby the first plane of the right bracket is attached to and flush with the inside surface of the right side panel and the second plane of the right bracket extends into the interior of the oven, with the right bracket situated at point on the right side panel corresponding to the location of the left bracket on the left side panel and oriented such that the second plane of the right bracket forms a generally horizontal shelf,
whereby the container is positioned upon the second plane of the left bracket and the second plane of the right bracket.

8. The device of claim 7 wherein the container is a generally rectangular pan with a substantially flat bottom, vertical sides, and open at the top, having a length slightly less than the width of the top panel and a width slightly less than the width of the left side panel.

9. The device of claim 7 whereby the left bracket is attached to the left side panel by pop rivets and the right bracket is attached to the right side panel by pop rivets.

10. The device of claim 3, further comprising a handle attached to the top panel.

11. The device of claim 10 whereby the handle folds flat against the top panel when not in use.

12. The device of claim 11 wherein the handle comprises
a rectangular grip composed of a heavy gauge metal wire and having two longer sides and two shorter sides, and
an attachment plate, having a generally rectangular shape and folded against itself, with the fold having a generally cylindrical shape in which to contain one longer side of the rectangular grip,
whereby one of the longer sides of the rectangular grip is placed into the cylindrical fold of the attachment plate and the attachment plate is attached to the top panel by pop rivets.

13. The device of claim 3, further comprising a support foot attached to the bottom panel.

14. The device of claim 13 whereby the support foot folds flat against the bottom panel when not in use.

15. The device of claim 14 wherein the support foot comprises
a rectangular foot composed of a heavy gauge metal wire and having a first long side, a second long side substantially identical in length to the first long side, a first short side, and a second short side substantially identical in length to the first short side,
an attachment plate, having a generally rectangular shape and folded against itself, with the fold having a generally cylindrical shape in which to contain one side of the rectangular foot,
whereby the first long side of the rectangular foot is placed into the cylindrical fold of the attachment plate, and the attachment plate is attached to the bottom panel by pop rivets.

16. The device of claim 15 wherein
a first angle of substantially ninety degrees is situated in the first short side of the rectangular foot closer to the first long side of the rectangular foot than to the second long side and
a second angle of substantially ninety degrees is situated in the second short side of the rectangular foot in substantially the same location along the second short side as the first angle is situated along the first short side
whereby the first angle and the second angle are oriented in the same direction towards the front of the reflector oven.

17. The device of claim 3 wherein the front edges of the top panel, bottom panel, and left and right side panels are rolled back onto themselves forming rounded edges and the side edges of the rear panel and the rear edges of the left and right side panels are folded onto themselves forming hemmed edges.
